(19) United States
(12) Patent Application Publication
(10) Pub. No.: US 2008/0190938 A1
(43) Pub. Date: Aug. 14, 2008

(54) Tank and Tank Insert

(75) Inventors: Sigurdur Bjarni Johannsson, Quispamsis (CA); Johann Gisli Sigurdsson, Gardner Creek (CA)

Correspondence Address: CONLEY ROSE, P.C.;David A. Rose, P. O. BOX 3267, HOUSTON, TX, 77253-3267, US

(73) Assignee: I-MARK INC., Gardner Creek (CA)

(21) Appl. No.: 11/672,997

(22) Filed: Feb. 9, 2007

(51) Int. Cl. F17C 1/02; B65D 25/00; B23P 19/04

(52) U.S. Cl. 220/586; 220/729; 29/700

(57) ABSTRACT

The invention relates to an improved tank structure having an outer shell of metal material with an inner surface and an outer surface, and an inner shell of a plastic resin material fused to the inner surface of the outer shell. The tank structure has at least two insert fittings mounted in corresponding openings formed in the outer shell, each insert fitting defining an opening for providing access to the interior of the tank structure. A top end of each insert fitting projects above the outer surface of the outer shell, and is formed with a peripheral flange for welding to the outer surface of the outer shell. The remaining body portion of each insert fitting extends into the interior of the tank structure and has a circumferential groove formed in the outer surface thereof which provides a gripping surface to which the inner shell is fused.

### FIELD OF THE INVENTION

The invention relates to tank structures having improved inner shells or linings.

### BACKGROUND OF THE INVENTION

Steel or metal tanks having thermoplastic or polymer liners are known. Typically, rotational molding is used for forming an inner polymer or thermoplastic liner within a metal outer tank. Generally, rotational molding involves placing a polymeric material in a mold or a tank. The mold or tank is then rotated about two axes while being heated to a temperature sufficient to melt the polymer. The mold or tank is rotated until the polymer has completely melted and has been evenly distributed about the interior of the rotated article. The mold or tank is then allowed to cool. If a mold is used, the formed polymer can then be removed therefrom and used as desired. For example, a method and apparatus for internally (and/or externally) coating enclosed metallic structures is disclosed in U.S. Pat. No. 5,728,423 (Rogerson).

Coating the interior surface of an enclosed tank structure has many advantages. The coating, which is often corrosion resistant, protects the underlying tank structure from its contents, thereby extending the life of the tank structure itself. The added protection provided by the liners helps to prevent leaks since the outer tank structure is less likely to succumb to the effects of corrosion; therefore the environment surrounding any such tank is less likely to be contaminated as a result of a tank failure. However, thermoplastic or polymer linings are sometimes prone to cracking or have weakened areas as the newly formed lining has a tendency to “shrink” while the tank cools after the rotational molding process. As well, it can be difficult to achieve a proper seal in the vicinity of the tank inlet or outlet ports.

U.S. Pat. No. 6,371,323 to Fernandes discloses an improved double wall tank having two or more threaded fittings. The double wall tank comprises an outer tank with a thermoplastic inner tank which is formed within the outer tank by rotational molding. The inner tank is bonded to the outer tank in an area of the fittings, but is otherwise separate and apart from the outer tank. Before carrying out the rotational molding process, bonding material is applied to the outer tank in the area of the fittings; therefore the inner liner is bonded to the inner surface of the outer tank in the vicinity of the fittings, but is separated from the inner surface of the outer tank in all other areas. The amount of shrinkage of the inner tank, however, can be controlled by air pressure. In the tanks disclosed by Fernandes bonding agent must be coated on the inner surface of the outer tank in areas considered to be of high stress, such as the areas proximal to and surrounding the fittings to ensure a proper seal is achieved.

U.S. Pat. No. 5,697,515 to Syler et al. discloses a tank and tank connector assembly wherein the tank is formed of an outer shell of metal material and an inner shell of polymer material. A connector assembly, the final form of which is formed by injection molding, is connected to the tank for forming the inlets and/or outlets of the tank. Each connector assembly comprises a flanged metal connector member which is welded to the outer shell of the metal material surrounding an opening. An insert member of polymer material is mounted in one end of the metal connector and the central portion is removed using a suitable cutting tool. The connector assembly is then subject to injection molding to form an internally threaded connector member on the inside of the metal connector member. The connector member has an internally threaded tubular wall portion and a depending nose portion that projects through the open central portion of the insert member. When the inner shell is formed by rotational molding the insert member and nose portion of the connector member are fused to the inner shell of the tank, the nose portion being subsequently removed to form an opening. While the tank connector assembly disclosed by Syler et al. may provide an improved seal at the junction of the inner shell and the connector assembly due to the fusing of the insert member to the inner shell, the connector assembly itself has multiple parts and is quite complex in terms of its assembly.

### SUMMARY OF THE INVENTION

In the present invention an insert fitting, which provides access to the interior of a tank structure having an outer shell lined with an inner shell, offers an improved tank structure less prone to leaks by providing a gripping surface which allows the inner shell of plastic resin material to securely fuse to the surface of the insert fitting thereby providing an improved seal between the outer shell and the inner shell in the area of the insert fitting.

According to one aspect of the invention there is provided a tank structure comprising an outer shell of metal material having an inner surface and an outer surface and an inner shell of a polymer material fused to the inner surface of the outer shell. A plurality of insert fittings are mounted in corresponding openings formed in the outer shell, each insert fitting defining an opening for providing access to the interior of the tank structure, and having a top end projecting above the outer surface of the outer shell, the top end being formed with a peripheral flange for welding to the outer surface of the outer shell, a body portion extending into the interior of the tank structure, and a circumferential groove formed in the outer surface of the body portion, the groove providing a gripping surface to which the inner shell is fused, wherein the inner shell that is fused to inner surface of the outer shell is also fused to the body portion of said plurality of insert fittings in a continuous manner.

According to another aspect of the invention there is provided an insert fitting for providing connection means to a tank structure having an outer shell of metal material and an inner shell of polymer material. The insert fitting comprises a tubular metal body member having a top end, a bottom end, and a body portion extending from the top end to the bottom end, and a body portion extending from the top end to the bottom end, the tubular body member defining an opening extending therethrough from the top end to the bottom end. A peripheral flange extends from the top end of the tubular body member beyond the diameter of the body portion, the peripheral flange providing a welding surface for welding the insert fitting to the tank structure. A circumferential groove is formed in the outer surface of the body portion between the peripheral flange and the bottom end, the circumferential groove providing a gripping surface to which the inner shell of the tank structure is fused.

According to a further aspect of the invention there is provided a method for forming a tank structure comprising the steps of (i) providing an enclosed outer shell of metal material having an inner surface and an outer surface and a plurality of openings formed therein, (ii) securing an insert fitting in each of the openings formed in the outer shell, each insert fitting defining an opening for providing access to the interior of said tank structure, and having a body portion extending into the interior of the tank structure with a circumferential groove formed in the outer surface of the body portion, the groove providing a gripping surface to which the inner shell is fused, (iii) securing the outer shell to an apparatus adapted to rotate the outer shell about a first axis and a second axis, (iv) depositing a charge of polymer material in powder form into the outer shell through the openings in the insert fittings, (v) sealing the openings in the insert fittings, (vi) pre-heating the insert fittings to a first temperature, (vii) rotating the outer shell about the first and second axes, (viii) heating the outer shell during the rotation to a second temperature sufficient to melt the charge of plastic resin material to coat the inner surface of the outer shell and the outer surface of the body portion of the insert fittings, thereby forming the tank structure.

### BRIEF DESCRIPTION OF THE DRAWINGS

Preferred embodiments of the invention will now be described, by way of example, with reference to the accompanying drawings, in which:

FIG. 1 is a perspective view of a tank structure according to a preferred embodiment of the invention;

FIG. 2 is a cross-sectional view of the tank structure of FIG. 1 taken along section lines 2-2;

FIG. 3 is a detail view of the area encircled in FIG. 2;

FIG. 4 is a perspective view of the insert fitting for use in the tank structure of FIG. 1; and

FIG. 5 is a detail view as shown in FIG. 3 wherein a removable plug is coupled to the insert fitting.

### DETAILED DESCRIPTION OF THE PREFERRED EMBODIMENT

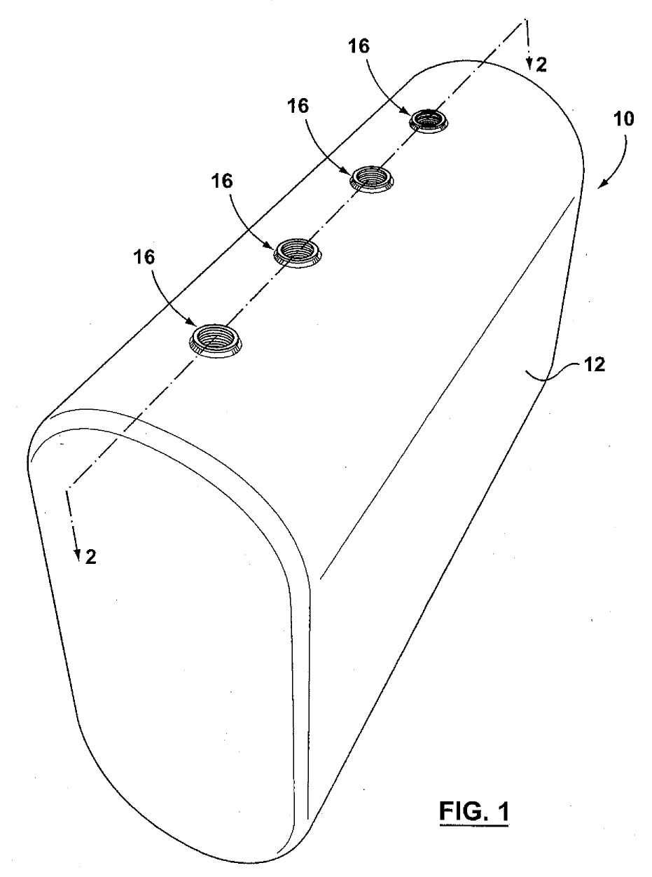

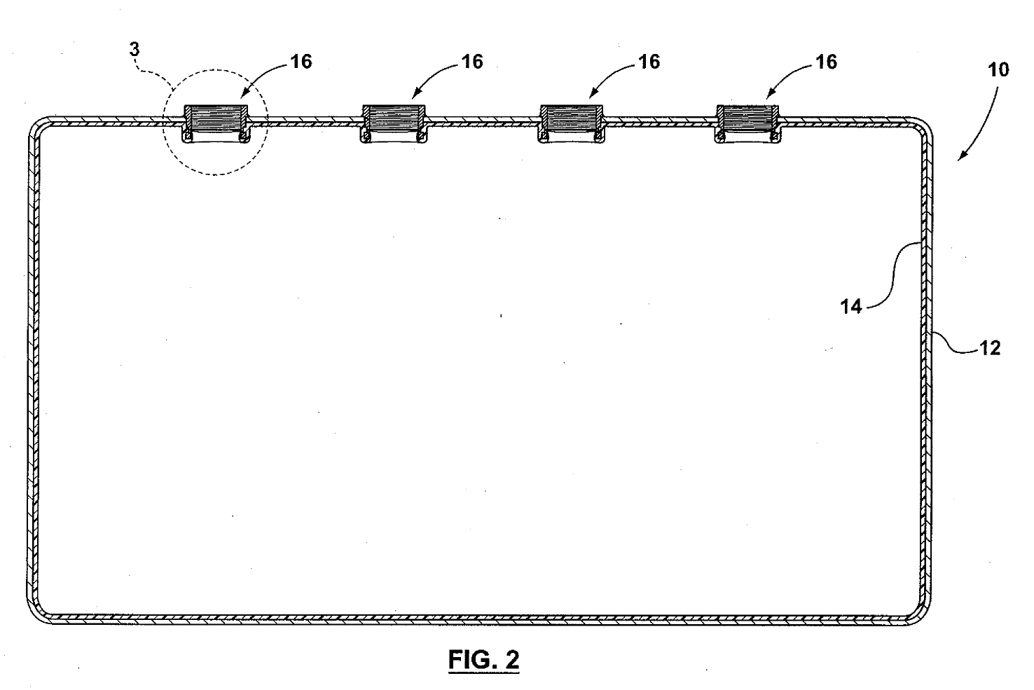

Referring to the drawings, there is shown in FIGS. 1 and 2 a tank structure 10 according to a preferred embodiment of the invention. Tank structure 10 is comprised of an outer shell 12 made of metal material and an inner shell 14 of polymer material. In the subject embodiment, the tank 10 has four insert fittings 16 located along a top or upper side of the tank structure 10 which provide access to the interior of the tank 10. However, it will be understood that the tank 10 may be formed with as few or as many fittings as required for a particular application and that the fittings 16 may located elsewhere on the tank as desired. Tank structure 10 is typically used as a storage tank for oil; however, the tank structure 10 may be used for storing any other suitable fluid.

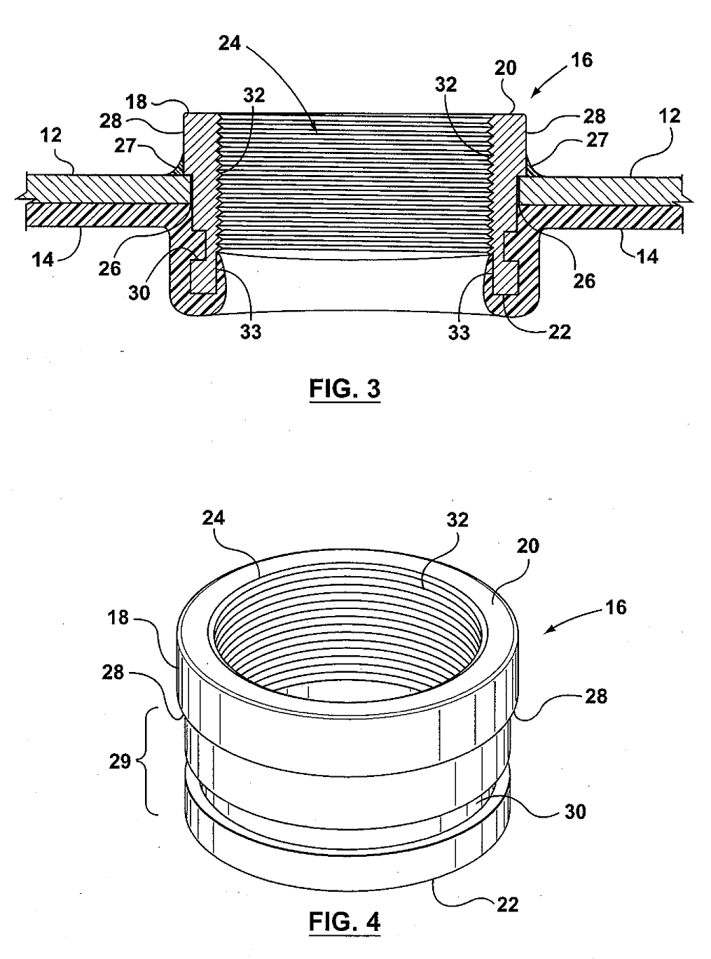

Referring now to FIGS. 3 and 4, insert fitting 16 comprises a tubular metal body member 18 having a top end 20 and a bottom end 22 and an opening 24 formed in the body member 18 extending from the top end 20 to the bottom end 22. Each insert fitting 16 is mounted in an opening 26 formed in the outer shell 12 of the tank structure 10. A peripheral flange 28 is formed around the top end 20 of the insert fitting 16 therefore the diameter of the top end 20 of the insert fitting 16 is larger than the diameter of the opening 26. Accordingly, the top end 20 of the insert fitting 16 projects above the outer surface of outer shell 12, while the remaining body portion 29 and bottom end 22 of the insert fitting 16 extends into the interior of the tank structure 10 through opening 26. The surface contact between the peripheral flange 28 and the outer surface of the outer shell 12 provides a welding area for welding the insert fitting 16 to the outer tank 12, as illustrated by weld bead 27.

As mentioned above, the remaining body portion 29 and bottom end 22 of the insert fitting 16 extends into to the interior of tank structure 10. A groove 30 is formed in the outer surface of body portion 29 around the circumference thereof. Groove 30 provides a gripping surface for the polymer material that is used to form the inner shell 14. The gripping action provided by the groove 30 helps to ensure that a proper seal is created around the insert fitting 16, which is typically an area prone to leaks.

The opening 24 formed in insert fitting 16 has internal threads 32 which provide a means for securing connection hoses and the like to the tank structure 10. In the subject embodiment, the internal threads 32 extend only partially down the opening 24 of the insert fitting 16, thereby leaving a bottom section 33 of the opening 24 unthreaded. It will be understood, however, that the threads 32 may extend the full length of the opening 24, if desired.

The opening 24 is adapted to receive removable plugs and/or valve members 34 which are required to seal the openings 24 in the insert fittings 16 when the tank is subject to manufacturing procedures, such as rotational molding, to form the inner shell 14. The removable plugs 34 each comprise a tubular body 36 having corresponding threads 38 on the outer surface thereof to mate with the threads 32 on the inside of the insert fitting 16. The tubular body 36 of the plugs 34 extends into the interior of the tank 12 beyond the bottom end 22 of the insert fitting 16. Having the plug extend beyond the bottom end 22 of the insert fitting 16 prevents the polymer material from covering the opening 24 when the inner shell 14 is formed. According to a preferred embodiment, the portion 39 of the plug 34 that extends below the threaded region 38 is tapered. The tapering of the lower portion 39 of the plug 34 provides a gap 40 between the inner wall of the insert fitting 16 and the lower portion of the plug 34. The gap 40 allows polymer material to coat the inside surface of the bottom section 33 of the insert fitting 16 during the rotational molding procedure. Having the polymer liner extend around the bottom of the insert fitting 16 and coat the inside of the lower portion of the insert fitting 16 acts as an added fluid barrier between the contents of the tank structure 10 and the metal components that make up the tank structure 10 which helps to prevent leaks in this area of the tank structure 10. The tapering of the lower portion 39 of the plug 34 also facilitates the insertion and removal of the plug 34 during the manufacturing process.

To manufacture the tank structure 10 described above, the outer shell 12 is provided with the desired number of openings 24 formed therein. Insert fittings 16 are then welded into the openings 26 to secure them in place. A charge of polymer material in powder form is introduced into the outer shell 12 through at least one of the openings 24 in the insert fittings 16. To form an inner shell 14 with approximately a ¼ inch wall thickness, approximately 30 kg of powder material is required.

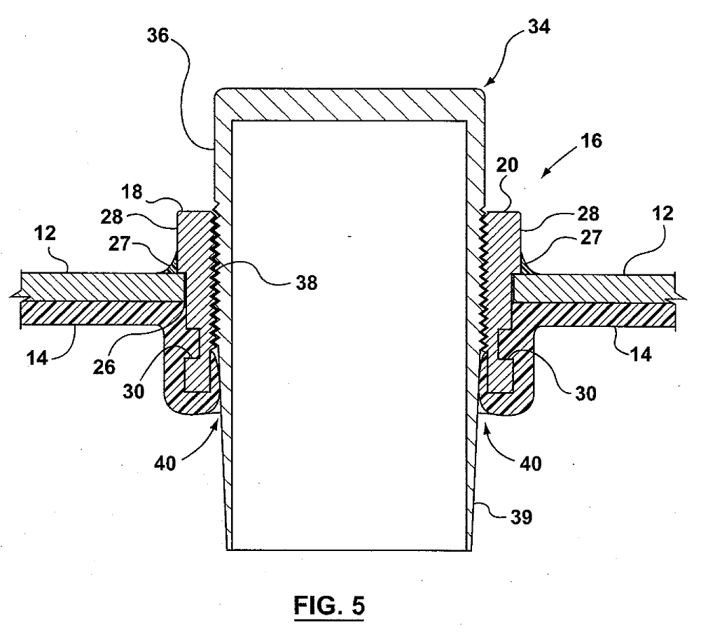

After the outer shell 12 is charged with the polymer material in powder form, removable plugs or valve members 34 are inserted into the openings 24 in the insert fittings 16 (see FIG. 5). The plugs or valve members 34 prevent any of the powdered polymer material from escaping from the interior of the outer shell 12 and provide a means for venting any gases from the interior of the outer shell 12 that can build up during rotational molding procedures. The plugs or valve members 34 are treated with a coating, for example a Teflon™ coating, to prevent any of the polymer material from bonding to the portion of the plug 34 that is exposed to the interior of the outer shell 12 as the plugs 34 are typically longer than the insert fittings 16 and, therefore, extend beyond the bottom end 22 of the insert fitting 16 into the interior of the outer shell 12 (see FIG. 5). As discussed above, this ensures that opening 24 in the insert fittings 16 does not become blocked by the polymer material during rotational molding procedures.

Once the plugs or valve members 34 have been inserted and screwed into each of the insert fittings 16, the insert fittings 16 are pre-heated to a surface temperature of about 300° F. at the weld joint using a laser gun, electrical heat or a flame. The outer shell 12 is then subjected to a rotational molding procedure wherein the outer shell 12 is rotated while being heated which causes the powdered material to melt and coat the inner surface of the outer shell 12 thereby forming inner shell 14. Rotational molding procedures typically occur in an oven, wherein the outer shell 12 is rotated about two different axes, a major axis and a minor axis for about 20 minutes while the outer shell 12 is heated to approximately 690° F. A typical ratio for the major axis to the minor axis is, for example, 4:1.5. As well, it will be understood that while an exemplary rotational moulding procedure has been described, the exact timing or duration of the specific steps described above can be adjusted to suit a particular application.

After the heating of the outer shell 12 and the formation of the inner shell 14, the tank structure 10 is allowed to cool for approximately 15 minutes while still being rotated. The tank structure 10 is then removed from the oven and allowed to cool for an additional 15 minutes, although the length of cooling time can be adjusted according to a particular application. Once the tank structure has cooled completely, the removable plugs or valve members 34 are removed. Once completely cooled and the plugs 34 have been removed, the tank structure 10 is then ready for use, with any threaded connection hose fittings or threaded pipe fittings being capable of being directly connected to the threaded insert fittings 16 in the tank structure 10.

While the present invention has been described with reference to a preferred embodiment, it will be understood by persons skilled in the art that the invention is not limited to the precise embodiment described, and that variations or modifications can be made without departing from the scope of the invention as disclosed herein. For example, in addition to having the inner shell 14 lining and protecting the interior of the outer shell 12, the outside surface of the outer shell can first be powder coated to provide additional protection to the outside of the tank structure. In a preferred embodiment, the powder coating is of a formulation that can withstand the rotational molding procedure; therefore the outer shell 12 can be powder coated prior to the rotational molding procedure.

We claim:

1. A tank structure comprising:
an outer shell of metal material having an inner surface and an outer surface;
an inner shell of a polymer material fused to the inner surface of said outer shell;
a plurality of insert fittings mounted in corresponding openings formed in the outer shell, each insert fitting defining an opening for providing access to the interior of said tank structure, and having:
a top end projecting above the outer surface of said outer shell, said top end being formed with a peripheral flange for welding to the outer surface of said outer shell;
a body portion extending into the interior of said tank structure; and
a circumferential groove formed in the outer surface of said body portion, said groove providing a gripping surface to which said inner shell is fused.
wherein said inner shell fused to the inner surface of said outer shell is also fused to the body portion of said plurality of insert fittings in a continuous manner.

2. A tank structure as claimed in claim 1, wherein said outer shell is powder coated.

3. A tank structure as claimed in claim 1, wherein said inner shell is substantially of a uniform thickness.

4. A tank structure as claimed in claim 1, wherein said plurality of insert fittings are all located on one side of said tank structure.

5. A tank structure as claimed in claim 1, wherein said opening in said insert fittings has an interior wall formed with internal threads extending partially down the interior wail of said opening.

6. A tank structure as claimed in claim 5, wherein said inner shell fused to the body portion of said insert fittings extends into the opening of each of said insert fittings along a portion of the interior wall thereof.

7. A tank structure as claimed in claim 1, wherein said tank structure includes three insert fittings.

8. A tank structure as claimed in claim 1, wherein said tank structure includes four insert fittings.

9. An insert fitting for providing connection means to a tank structure having an outer shell of metal material and an inner shell of polymer material, said insert fitting comprising:
a tubular metal body member having a top end, a bottom end, and a body portion extending from the top end to the bottom end, said tubular body member defining an opening extending therethrough from said top end to said bottom end;
a peripheral flange extending from said top end of said tubular body member beyond the diameter of said body portion, said peripheral flange providing a welding surface for welding said insert fitting to a tank structure;
a circumferential groove formed in the outer surface of said body portion between said peripheral flange and said bottom end, said circumferential groove providing a gripping surface to which said inner shell is fused.

10. An insert fitting as claimed in claim 9, wherein said opening is a partially threaded opening.

11. A method of forming a tank structure comprising the steps of:
providing an enclosed outer shell of metal material having an inner surface and an outer surface and a plurality of openings formed therein;
securing an insert fitting in each of said openings in said outer shell, each insert fitting defining an opening for providing access to the interior of said tank structure, each insert fitting having a body portion extending into the interior of said tank structure with a circumferential groove formed in the outer surface of said body portion, said groove providing a gripping surface to which said inner shell is fused;
securing said outer shell to an apparatus adapted to rotate said outer shell about a first axis and a second axis;
depositing a charge of polymer material in powder form into said outer shell through said openings in said insert fittings;
sealing the opening in said insert fittings;
pre-heating said insert fittings to a first temperature;
rotating said outer shell about said first and second axes;
heating said outer shell during said rotation to a second temperature sufficient to melt said charge of polymer material to coat the inner surface of said outer tank and the outer surface of the body portion of said insert fittings.

12. A method as claimed in claim 11, further comprising the step of cooling said tank structure.

13. A method as claimed in claim 12, wherein said cooling step occurs while said tank structure is rotating.

14. A method as claimed in claim 11, wherein the ratio of said first axis to said second axis is 4:1.5.

15. A method as claimed in claim 11, wherein said first temperature is a surface temperature of approximately 300° F.

16. A method as claimed in claim 11, wherein said second temperature is approximately 690° F.

17. A method as claimed in claim 11, wherein said outer shell is powder coated prior to securing said outer shell in said apparatus for rotating said outer shell.

18. A method as claimed in claim 11, wherein the step of pre-heating the insert fittings is performed using a laser gun.

19. A method as claimed in claim 11, wherein the step of pre-heating the insert fittings is performed using a flame.

20. A method as claimed in claim 11, wherein the step of pre-heating the insert fittings is performed using electrical heat.
